(19) United States
(12) Patent Application Publication
(10) Pub. No.: US 2012/0195595 A1
(43) Pub. Date: Aug. 2, 2012

(54) IMPROVEMENTS IN EXTRACTING OPTICAL LABELS

(76) Inventors: Antonella Bogoni, Mantova (MN) (IT); Mirco Scaffardi, Parma (IT); Paolo Ghelfi, Goito (MN) (IT); Luca Poti, Pisa (IT)

(21) Appl. No.: 13/499,710

(22) PCT Filed: Oct. 20, 2009
(86) PCT No.: PCT/EP2009/063722

§ 371 Date: Apr. 2, 2012

(30) Foreign Application Priority Data
Oct. 1, 2009 (EP) 09171911.2

(51) Int. Cl. H04J 14/02

(52) U.S. Cl. 398/49; 398/79

(57) ABSTRACT

An optical label extractor (10) comprising a non-linear optical element (12), a pump source (14) and optical filter apparatus (16). Said non-linear optical element (12) is arranged to receive optical data packets (18) at data signal wavelengths. Each said data packet comprises at least one data bit and at least one label bit. Said pump source (14) is arranged to pump said non-linear optical element such that any non-zero label bit experiences a non-linear optical effect on propagation through said non-linear optical element and an output label bit (20) comprising a respective further wavelength is thereby generated. Said optical filter apparatus (16) is arranged to receive any said output label bit from said non-linear optical element and being further arranged to prevent transmission of a part of said output label at said respective data signal wavelength and to transmit a part of said output label bit at said respective further wavelength.

### FIELD OF THE INVENTION

The invention relates to an optical label extractor, an optical router comprising the optical label extractor, a method of extracting optical labels from optical data packets and a method of routing optical data packets.

### BACKGROUND OF THE INVENTION

Multi-wavelength label extraction, i.e. the extraction of the bits of labels at different wavelengths, is a key capability for developing all-optical packet switched (OPS) networks. The use of wavelength division multiplexing (WDM) techniques in OPS networks allows simple multiplexing and demultiplexing operations. Moreover multi-wavelength packet transmission increases the network flexibility and the throughput at network nodes. Optical label extraction from single optical data packets, i.e. for a single data channel, has been carried out using cross gain modulation in semiconductor optical amplifiers, as reported by Scaffardi M. et al, “160 Gb/s/port 2×2 OPS node test-bed performing 50 Gchip/s all-optical active label processing with contention detection”, Proc. Photonics in Switching 2008, PD.1, Aug. 4-7, 2008. In order to obtain label extraction for all optical data packets transmitted on a number of channels of a WDM optical packet switching based network, a very large number of single packet label extractors are needed, with a high total power consumption, cost and complexity.

### SUMMARY OF THE INVENTION

It is an object to provide an improved optical label extractor. It is a further object to provide an improved optical network router. It is a further object to provide an improved method of extracting optical labels from optical data packets. It is a further object to provide an improved method of routing optical data packets.

A first aspect of the invention provides an optical label extractor comprising a non-linear optical element, a pump source and optical filter apparatus. Said non-linear optical element is arranged to receive optical data packets at a first plurality of data signal wavelengths. Each said data packet comprises at least one data bit and at least one label bit. Said pump source is arranged to pump said non-linear optical element such that any non-zero label bit at a respective data signal wavelength experiences a non-linear optical effect on propagation through said non-linear optical element. For each said non-zero label bit an output label bit is generated comprising a respective further wavelength. Said optical filter apparatus is arranged to receive from said non-linear optical element any said output label bit. Said optical filter apparatus is further arranged to prevent transmission of a part of any said output label bit at said respective data signal wavelength and to transmit a part of said output label bit at said respective further wavelength.

The optical label extractor is thus able to implement multi-wavelength label extraction using a single non-linear optical element. The optical label extractor provides serial label extraction at each wavelength. This provides reduced power consumption, complexity and cost as compared with known optical label extractors and is more compact than known optical label extractors.

The optical label extractor may be used with both return-to-zero (RZ) data and non-return-to-zero (NRZ) data formats.

In an embodiment, said optical filter apparatus comprises a said first plurality of outputs. Said optical filter apparatus is arranged to receive from said non-linear optical element any said output label bit. Said optical filter apparatus is arranged to transmit a part of any said output label bit at said respective further wavelength to a respective said output.

The optical label extractor is thus arranged to optically extract an optical label bit from optical data packets at each of a plurality of wavelengths and to provide the extracted optical label bit at a respective output. In an embodiment, said pump source comprises an optical source arranged to generate a pump optical signal and to deliver said pump optical signal to said non-linear optical element. Said non-linear optical effect comprises one of cross-phase modulation and four-wave-mixing. Said respective further wavelength is therefore a wavelength within the additional wavelength spectrum added to a non-zero label bit by the effect of cross-phase modulation within said non-linear optical element or is a wavelength of a conjugate wave generated by the effect of four-wave-mixing within said non-linear optical element.

In an embodiment, said non-linear optical effect comprises both cross-phase modulation and four-wave-mixing. Any said output label bit thus comprises two further wavelengths, one within the wavelength spectrum generated by the effect of cross-phase modulation and one within the wavelength spectrum of a conjugate wave generated by the four-wave-mixing. A selection of a further wavelength is thus enabled.

In an embodiment, each said optical data packet comprises a second plurality of label bits. Said pump source further comprises a controller arranged to control said optical source to generate a pump optical signal comprising a said second plurality of pump pulses. Said pump source is further arranged to deliver said pump pulses to said non-linear optical element such that each said pump pulse at least partly temporally overlaps with a respective said label bit at each said data signal wavelength. Each pump pulse thus at least partly overlaps with a different label bit of a data packet. A first pump pulse simultaneously at least partly overlaps with a first label bit at each said wavelength, a second pump pulse simultaneously at least partly overlaps with a second label bit at each said wavelength, and so on.

In an embodiment, said label bits have a repetition rate and said controller is arranged to control said optical source to generate pump pulses having a repetition rate which is substantially the same as said repetition rate of said label bits. Said pump pulses thus fully overlap with said respective label bits. In an embodiment, said controller is arranged to control said optical source to generate a series of said pump pulses. Said series of pump pulses comprises a said second plurality of pump pulses. Therefore only said label bits are caused to experience said non-linear optical effect. In an embodiment, said optical source comprises an optical modulator and said controller comprises a gate. Said optical source is arranged to generate an optical signal and said optical modulator is arranged to modulate said optical signal to generate said pump pulses. Said gate is arranged to control said optical modulator to generate said series of pump pulses.

In an embodiment, each said optical data packet comprises a third plurality of label bits. Said optical source is arranged to generate a pump optical signal comprising a pump pulse. Said optical label extractor further comprises first optical splitter apparatus, second optical splitter apparatus, a said third plurality of said non-linear optical element, a said third plurality of time delay elements and a said third plurality of said optical filter apparatus. Said first optical splitter apparatus is arranged to split each said data packet into a said third plurality of replica data packets. Said non-linear optical elements are each arranged to receive a respective one of said replica data packets. Said second optical splitter apparatus is arranged to split said pump pulse into a said third plurality of replica pump pulses. Said second optical splitter apparatus is further arranged to deliver each said replica pump pulse to a respective said non-linear optical element. Said time delay elements are respectively provided between said second optical splitter apparatus and each said non-linear optical element. Each said time delay element is arranged to apply a time delay of a different duration to a respective replica pump pulse. Consequently, each said replica pump pulse is delivered to said respective non-linear optical element at a different time. Each said replica pump pulse thus at least partly temporally overlaps with a different said label bit at each said data signal wavelength.

Temporally and spatially separated extracted label bits are thus output from the optical label extractor. Said optical label extractor thus provides parallel label extraction at each said wavelength, the first label bit of each optical data packet being extracted in parallel at a first time, the second label bit of each optical data packet being extracted in parallel at a second time, and so on.

In an embodiment, said pump optical signal has an optical power arranged to cause gain saturation of said non-linear optical element. In an embodiment, said pump pulses have an optical power arranged to cause gain saturation of said non-linear optical element on a leading edge of each said pump pulse.

In an embodiment, said pump optical signal has a wavelength which is either shorter than or longer than each wavelength of said first plurality of data signal wavelengths. The pump optical signal wavelength is thus located outside the wavelength range occupied by said first plurality of data signal wavelengths.

In an embodiment, each said label bit has an optical power which is lower than said optical power of a respective said pump pulse. This ensures that said label bits do not cause gain saturation of said non-linear optical element, so gain saturation is only caused by said pump pulses.

In an embodiment, the or each said non-linear optical element comprises one of a semi-conductor optical amplifier and a non-linear optical waveguide. The waveguide is a planar optical waveguide or an optical fibre. Use of a semi-conductor optical amplifier is particularly advantageous as it provides higher four-wave-mixing efficiency than a non-linear optical waveguide and thus results in a larger detuning of the further wavelength than is produced using a non-linear optical fibre or planar waveguide.

In an embodiment, where said non-linear optical element comprises a semi-conductor optical amplifier, said optical label extractor further comprises a further optical source. Said further optical source is arranged to generate a recovery optical signal and to deliver said recovery optical signal to said semi-conductor optical amplifier. Said recovery optical signal is a continuous wave optical signal. After a pump pulse has been transmitted through said semi-conductor optical amplifier the gain of said semi-conductor amplifier recovers. Delivering said recovery optical signal to said semi-conductor optical amplifier maintains the gain of said semi-conductor optical amplifier slightly saturated and thus reduces the time required for said semi-conductor optical amplifier to recover its gain.

In an embodiment, each said data packet has a return-to-zero or non-return-to-zero data signal format and said pump optical signal is of a same said data signal format.

In an embodiment the or each said optical filter apparatus comprises an arrayed waveguide grating. In an embodiment, where said non-linear optical amplifier comprises a semi-conductor optical amplifier, said optical filter apparatus further comprises an optical amplifier and a bandpass optical filter. Said optical amplifier is arranged to receive and amplify a said filtered output label bit at a respective said further wavelength. Said bandpass optical filter is arranged to receive said filtered output label bit from said optical amplifier. Said bandpass optical filter acts to remove any amplified spontaneous emission noise added to said output label bit on transmission through said semi-conductor optical amplifier. In an embodiment, said optical amplifier comprises one of a semi-conductor optical amplifier and an Erbium doped waveguide amplifier.

In an embodiment, the or each said optical filter apparatus comprises an optical splitter and a said first plurality of optical filters. Said optical splitter is arranged to receive an optical signal from a respective said non-linear optical element and to split said optical signal into a said first plurality of optical signals. Said optical filters are each arranged to receive a respective one of said split optical signals and to transmit optical signals at a different one of said further wavelengths to a respective said output.

In an embodiment, the or each said non-linear optical element is arranged to transmit each respective said data packet and the or each said optical filter apparatus is arranged to receive each respective said data packet and any said output label bit from said non-linear optical element and is further arranged to prevent transmission of each respective said data packet.

A second aspect of the invention provides an optical network router comprising an optical label extractor as described above, optical switch apparatus and a controller. Said controller is arranged to receive a label signal indicative of an extracted label from said label extractor. Said controller is further arranged to generate a control signal for controlling said optical switch apparatus in accordance with said extracted label.

A third aspect of the invention provides a method of extracting optical labels from optical data packets. Said method comprises receiving optical data packets at a first plurality of data signal wavelengths. Each said data packet comprises at least one data bit and at least one label bit. Said method further comprises causing each respective said at least one label bit to experience a non-linear optical effect such that where a respective said at least one label bit comprises a non-zero label bit a respective output label bit comprising a respective further wavelength is thereby generated. Said method further comprises filtering any respective said output label bit to prevent transmission of a part of said output label at said respective data signal wavelength and to transmit a part of said output label bit at said respective further wavelength. The method thereby enables optical labels to be simultaneously extracted from optical data packets at a plurality of data signal wavelengths. The method can thus be applied to a wavelength division multiplexed optical network.

In an embodiment, each said at least one label bit is caused to experience said non-linear optical effect by transmitting said respective optical data packet through a non-linear optical element. Said non-linear optical element is pumped by a pump source to cause each said at least one label bit to experience said non-linear optical effect on transmission therethrough.

In an embodiment, each said optical data packet comprises a second plurality of label bits. Said method comprises splitting each said data packet into a said second plurality of replica data packets. Each of said second plurality of label bits of each said replica data packet is caused to experience a non-linear optical effect at a respective different time. Said method further comprises filtering each said output label bit to prevent transmission of a part of said output label at said respective data signal wavelength and to transmit a part of said output label bit at said respective further wavelength. Spatially and temporally separated output label bits are thereby transmitted.

In an embodiment, each said at least one label bit is caused to experience said non-linear optical effect by transmitting said respective replica data packet through a non-linear optical element. Said non-linear optical element is pumped by a pump source to cause said at least one label bit to experience said non-linear optical effect on transmission therethrough.

In an embodiment, said non-linear optical effect comprises one of cross-phase modulation and four-wave-mixing.

In an embodiment, said method further comprises filtering each said optical data packet or each said replica data packet after said non-linear effect to prevent transmission of each said data packet. Therefore only said part of each said output label bit at said further wavelength is transmitted.

A method of routing optical data packets comprising receiving optical data packets to be routed. Each said data packet comprises at least one data bit and at least one label bit. Said method further comprises extracting a respective optical label from said optical data packets according to any of the above steps of the method of extracting optical labels from optical data packets. Said method further comprises establishing a routing path for each said optical data packet in accordance with said respective extracted optical labels.

### BRIEF DESCRIPTION OF THE DRAWINGS

FIG. 1 is a diagrammatic representation of an optical label extractor according to a first embodiment of the invention;

FIG. 2 is a diagrammatic representation of an optical label extractor according to a second embodiment of the invention;

FIG. 3 is a diagrammatic representation of an optical label extractor according to a third embodiment of the invention;

FIG. 4 shows input label pulses, pump pulse, spectrally broadened label pulses, conjugate wave label pulses and wavelength selective routing apparatus filter wavelengths of the optical label extractor of FIG. 3;

FIG. 5 is a diagrammatic representation of an optical label extractor according to a fourth embodiment of the invention;

FIG. 6 is a diagrammatic representation of an optical label extractor according to a fifth embodiment of the invention;

FIG. 7 is a diagrammatic representation of router according to a sixth embodiment of the invention;

FIG. 8 shows the steps of a method of extracting optical labels from optical data packets according to a seventh embodiment of the invention;

FIG. 9 shows the steps of a method of extracting optical labels from optical data packets according to an eighth embodiment of the invention; and

FIG. 10 shows the steps of a method of routing optical data packets according to a ninth embodiment of the invention.

### DESCRIPTION OF EMBODIMENTS OF THE INVENTION

Referring to FIG. 1, a first embodiment of the invention provides an optical label extractor 10 comprising a non-linear optical element 12, a pump source 14 and optical filter apparatus 16. The non-linear optical element 12 is arranged to receive optical data packets 18 at a plurality of data signal wavelengths, λ1 to λN (only one data signal wavelength, λ1, is shown for clarity). Each data packet 18 comprises at least one data bit and at least one label bit. The label bit may be a non-zero label bit, being an optical pulse having a non zero optical power, or maybe a zero label bit, being an optical pulse having zero or low optical power. The data packet may have a return to zero (RZ) or a non-return-to-zero (NRZ) data format.

The pump source 14 is arranged to pump the non-linear optical element 12 such that any non-zero label bit propagating through the non-linear optical element experiences a non-linear optical effect. As a result of the non-linear optical effect experienced by a non-zero label bit, a respective output label bit 20 comprising a respective further wavelength (in this example λ1′, λ1*) is generated. For each non-zero label bit, the respective output label bit 20 therefore includes the label bit at the data signal wavelength, e.g. λ1, plus the respective further wavelength, e.g. λ1′, λ1*.

The optical filter apparatus 16 is arranged to receive any output label bit 20 from the non-linear optical element 12. The optical filter apparatus 16 is arranged to prevent transmission of a part of any output label at the respective data signal wavelength, e.g. λ1, i.e. to prevent transmission of the original label bit. The optical filter apparatus 16 is further arranged to transmit a part of each output label bit at its respective further wavelength, in this example λ1*.

Extracted optical labels 22 comprising the data of the respective label bits 18 are thus produced at the respective further wavelengths, e.g. λ1*.

It will be noted that the non-linear optical effect is only experienced by the label bits of each optical data packet 18, the data bits being unaffected and transmitted by the non-linear optical element 12 at the respective data signal wavelength. The data packets 24 output from the non-linear optical element thus comprises the data bits at the respective data signal wavelength, e.g. λ1, and the respective output label bits 20. The data bits at the respective data signal wavelengths are also prevented from being transmitted by the optical filter apparatus 16, so that the output from the optical filter apparatus 16 comprises only the extracted optical labels 22 at the respective further wavelengths.

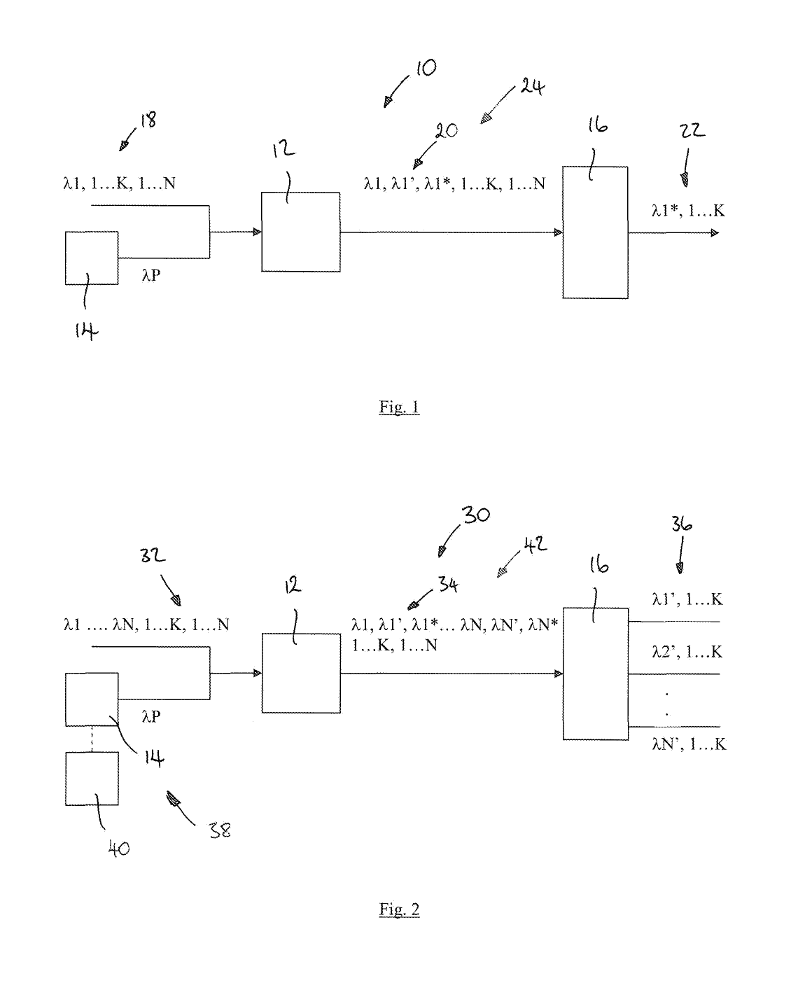

Referring to FIG. 2, a second embodiment of the invention provides an optical label extractor 30 which is substantially the same as the optical label extractor 10 of the first embodiment of the following modifications. The same reference numbers are retained for corresponding features.

In this embodiment the non-linear optical element 12 is arranged to receive optical data packets 32 at a plurality of data signal wavelengths, λ1 to λN. Each data packet 32 comprises a second plurality of label bits, 1 to K, and a third plurality of data bits, 1 to N.

The pump source is arranged to pump the non-linear optical element 12 such that any non-zero label bits K at the data signal wavelengths λ1 to λN will each experience a non-linear optical effect on propagation through the non-linear optical element 12. A corresponding output label bit 34 is generated for each non-zero label bit at each respective further wavelength λ1′, λ1* to λN′, λN*. Data packets 42 output from the non-linear optical element 12 thereby comprise output label bits, 1 to K, 34 at each of the input label bit wavelengths λ1 to λN and at each of the further wavelengths λ1*, λ1′ to λN*, λN′ and data bits, 1 to N, at the input data signal wavelengths λ1 to λN.

The pump source 38 comprises an optical source 14 and a controller 40. The optical source 14 is arranged to generate a pump optical signal λP and to deliver the pump optical signal to the non-linear optical element 12. The controller 40 is arranged to control the optical source to generate a pump optical signal comprising a second plurality of pump pulses. The pump optical signal is therefore generated as a series of pump optical pulses. The number of pump optical pulses in the pump signal series is the same as the number of label bits K in the optical data packet 32. The controller 40 is arranged to control the optical source 14 to generate the series of optical pump pulses to have the same repetition rate as the label bits K and to deliver the series of pump optical pulses to the non-linear optical element 12 such that each pump optical pulse temporally overlaps with a respective label bit K. That is to say, the first pump pulse in a series of pump pulses will overlap with the first label bit of each optical data packet 32, the second pump pulse in the series will overlap with the second label bit of each optical data packet 32, and so on. It is not essential that the pump pulses fully overlap with the respective label bit but the more closely pump pulses overlap with their respective label bits the more efficiently the further wavelengths are generated.

The optical filter apparatus 16 is arranged to receive the output data packets 34 from the non-linear optical element 12. In this example, the optical filter apparatus 16 is arranged to transmit a part of each output label bit, 1 to K, at each respective further wavelength λ1′, λN′. The optical label extractor 30 thereby outputs extracted optical labels 36 comprising the label bits, 1 to K, at each of the respective further wavelengths λ1′ to λN′ for each of the input data signal wavelengths, λ1 to λN. The optical label extractor 30 thereby serially extracts the label bits 1 to K of each input optical data packet 32 and spatially separates the extracted optical labels 36 at each of the further wavelengths λ1′ to λN′.

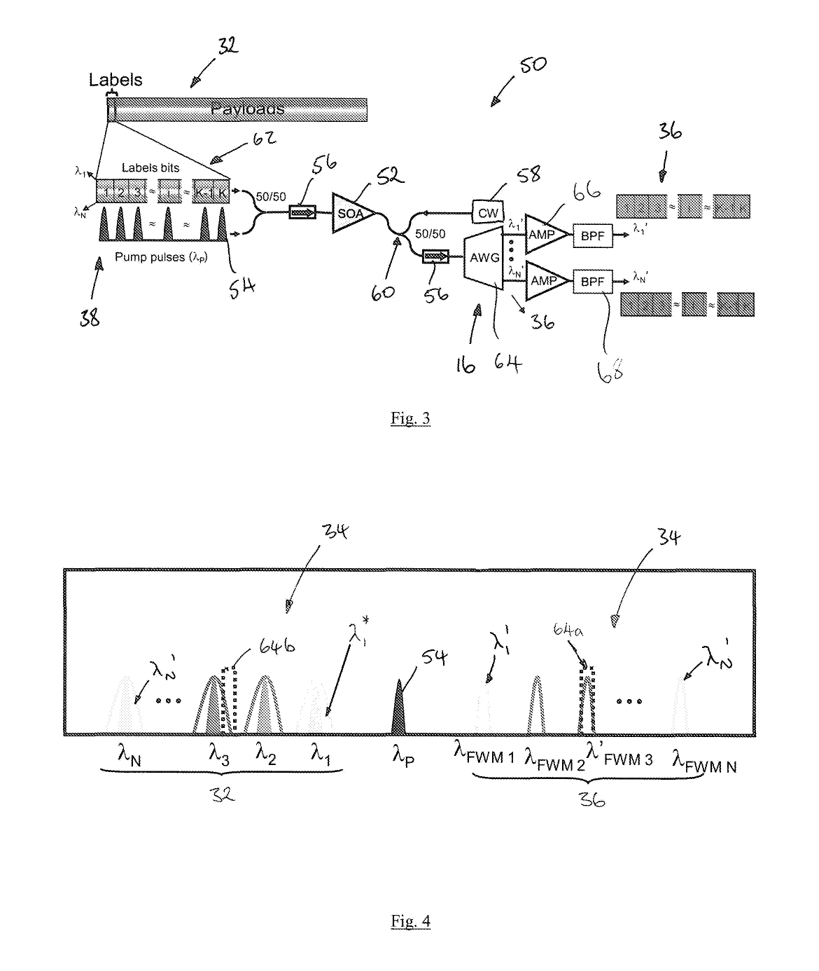

Referring to FIGS. 3 and 4, a third embodiment of the invention provides an optical label extractor 50 which is substantially the same as the optical label extractor 30 of FIG. 2, with the following modifications. The same reference numbers are retained for corresponding features.

In this embodiment, the non-linear optical element comprises a semi-conductor optical amplifier (SOA) 52. The SOA 52 is arranged to receive optical data packets 32 at data signal wavelengths, λ1 to λN, each optical data packet 32 comprising K label bits. The pump source 38 is arranged to deliver a series of pump pulses 54 to the SOA 52, as described above. The optical data packets 32 and pump pulses 54 are delivered to the SOA 52 through an optical isolator 56.

In this embodiment the optical label extractor 50 further comprises a further optical source 58 arranged to generate a continuous wave (CW) recovery optical signal which is delivered to the SOA 52 in a counter propagating configuration via a 50/50 optical coupler 60. The CW recovery optical signal is arranged to keep the SOA 52 slightly saturated so that the time for the SOA to recover its maximum available gain is reduced following propagation of a pump optical pulse through the SOA 52.

The pump pulses 54 have an optical power which ensures that the SOA gain is saturated at the leading edge of each pump pulse 54.

The output from the SOA 52 is routed via the 50/50 coupler 60 and a second optical isolator 56 to the optical filter apparatus 16. The output from the SOA 52 comprises an output data packet comprising output label 34, as shown in FIG. 4, and the data bits from the optical data packets 32.

In this embodiment, the pump optical pulses cause gain saturation of the SOA 52 such that on propagation through the SOA 52 non-zero label bits 62 experience cross-phase modulation (XPM) and four-wave-mixing (FWM) respectively producing output label bits comprising further wavelengths λN*, λN′. The further wavelength generated for a non-zero label bit as a result of XPM comprises a wavelength within the additional spectral range added to the label bit 62 due to the spectral broadening caused by the XPM. The further wavelength generated as a result of the FWM comprises the wavelength of the resulting FWM conjugate wave signal.

In this embodiment, the optical filter apparatus comprises an arrayed waveguide grating (AWG) 64 arranged to receive the output from the SOA 52. The AWG 64 has N output ports each arranged to transmit optical signals at one of the FWM conjugate wave signal wavelengths, λ1′ to λN′. The AWG 64 acts to transmit optical signals at the conjugate wave wavelengths and prevents transmission at all other wavelengths, thereby preventing onward transmission of the original label bits 62 and the data bits at the data signal wavelengths λ1 to λN. The AWG 64 thereby effectively applies a filter 64a at each respective FWM conjugate wave wavelength. It will be appreciated that the AWG may alternatively be arranged to transmit one or more of the XPM wavelengths and would thereby apply a filter function 64b to transmit one or more of the wavelengths within the spectrally broadened wavelength range added to each label bit by XPM.

The extracted optical labels 36 at each wavelength are routed from their respective output port of the AWG 64 to an optical amplifier 66, which may comprise a further SOA or an erbium doped waveguide amplifier. The optical filter apparatus further comprises a bandpass filter (BPF) 68 arranged to transmit the respective further wavelength λ1′ to λN′ and to substantially prevent transmission at all other wavelengths. The BPF 68 serves to remove amplified spontaneous emission noise added to the output label bits by the SOA 52. The optical label extractor 50 thereby outputs extracted optical labels 36 at each of the respective further wavelengths, λ1′ to λN′. The optical label extractor 50 thereby serially extracts the label bits 1 to K at each further wavelength, and spatially separates the outputs at each further wavelength.

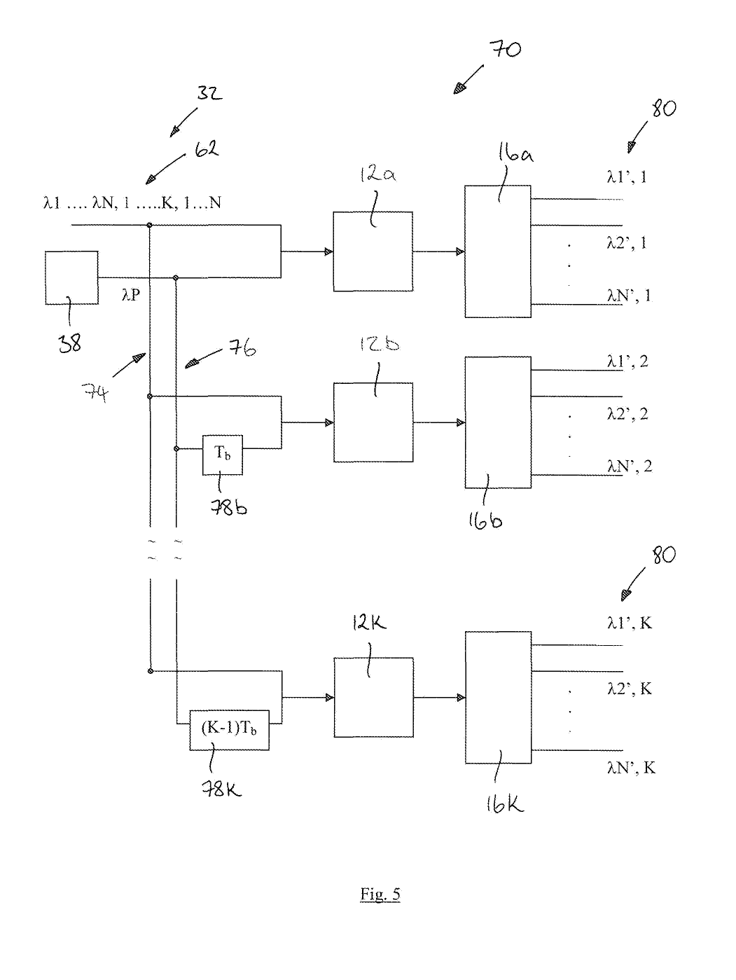

A fourth embodiment of the invention provides an optical label extractor 70, as shown in FIG. 5. The optical label extractor 70 is based on the optical label extractor 30 of FIG. 2 and the same reference numbers are retained for corresponding features.

The optical label extractor 70 of this embodiment is arranged to receive optical data packets 32 at a plurality of data signal wavelengths, λ1 to λN, each data packet comprising K label bits 62 and N data bits. The optical label extractor 70 essentially comprises K optical label extractors 30, having a shared pump source 38.

The pump source 38 is arranged to generate a pump pulse at the pump wavelength λP. The optical label extractor 70 further comprises first optical splitter apparatus 74 and second optical splitter apparatus 76. The first optical splitter apparatus 74 comprises a branching network of optical waveguides arranged to split each optical data packet 32 into K equal replica data packets and to route each replica data packet to a respective non-linear optical element 12. The pump source 38 is arranged to generate a single pump pulse and the second optical splitter apparatus 76 comprises a second network of optical waveguides arranged to split the pump pulse into K replica pump pulses and to route each replica pump pulse to a respective non-linear optical element 12.

The optical label extractor 70 additionally comprises K−1 time delay elements 78b to 78K. The time delay elements 78 are provided in the optical waveguide paths between the pump source 38 and the SOA of the second (12b) to the final (12K) SOA. Each time delay element 78 applies a multiple of a time delay T_{b}. The second non-linear optical element 12b therefore has a time delay element 78b which applies a single time delay T_{b} to the respective replica pump pulse and the final non-linear optical element 12K has a time delay element 78K which applies a time delay (K−1) T_{b} to the respective replica pump pulse.

The time delay T_{b} is equal to the bit period of the label bits 62. The time delay elements 78 control delivery of the respective replica pump pulses to the respective non-linear optical element 12 such that the replica pump pulse arriving at each non-linear optical element 12 will temporally overlap with a different one of the replica label bits. That is to say, the replica pump pulse delivered to the first non-linear optical element 12a will temporally overlap with the first label bit (1) of the replica label bits received at the first SOA. The first label bit will thereby be extracted at each further wavelength λ1′ to λN′. The replica pump pulse delivered to the second non-linear optical element 12b will have a time delay T_{b} applied to it. By delaying the replica pump pulse by one label bit period the replica pump pulse will arrive at the non-linear optical element 12b such that it temporally overlaps with the second label bit of each data packet. The second label bit (2) will thereby be extracted at each further wavelength λ1′ to λN′. The replica pump pulse delivered to the final non-linear optical element 12K will have a time delay of (K−1) T_{b} such that it arrives at the non-linear optical element 12 to temporally overlap with the final label bit K of each data packet. Extracted optical labels 80 at each further wavelength λ1′ to λN′ are thereby produced.

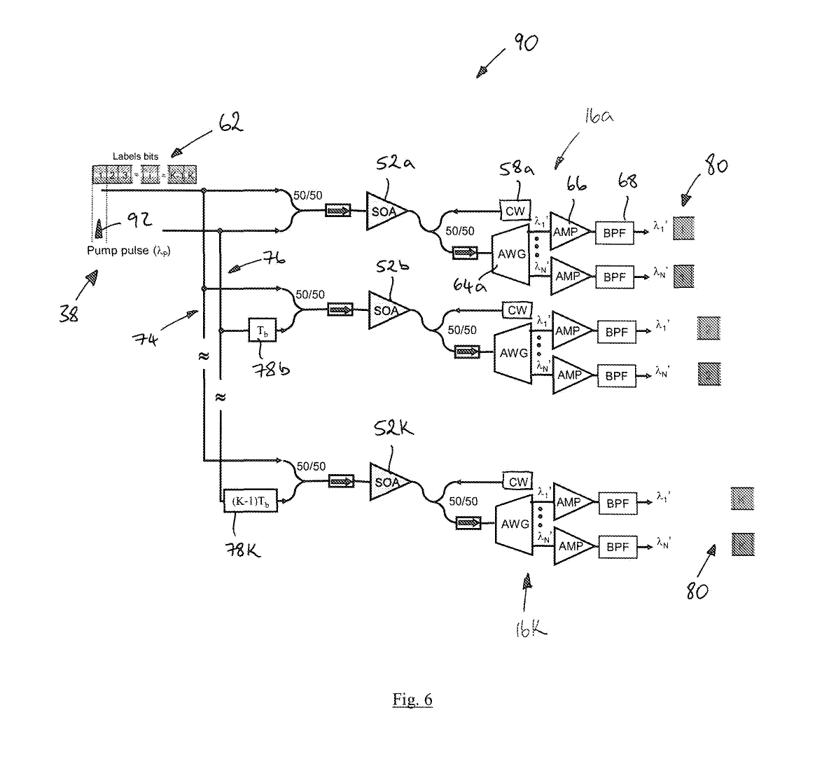

A fifth embodiment of the invention provides an optical label extractor 90, as shown in FIG. 6. The optical label extractor 90 is substantially the same as the optical label extractor 70, with the following modifications. The same reference numbers are retained for corresponding features.

In this embodiment, the optical label extractor 90 essentially comprises K optical label extractors 50 as shown in FIG. 3, with a common pump source 38. The non-linear optical element of this embodiment therefore comprises an SOA 52. It will be appreciated that the SOA 52 may alternatively comprise a non-linear optical fibre or a non-linear optical waveguide.

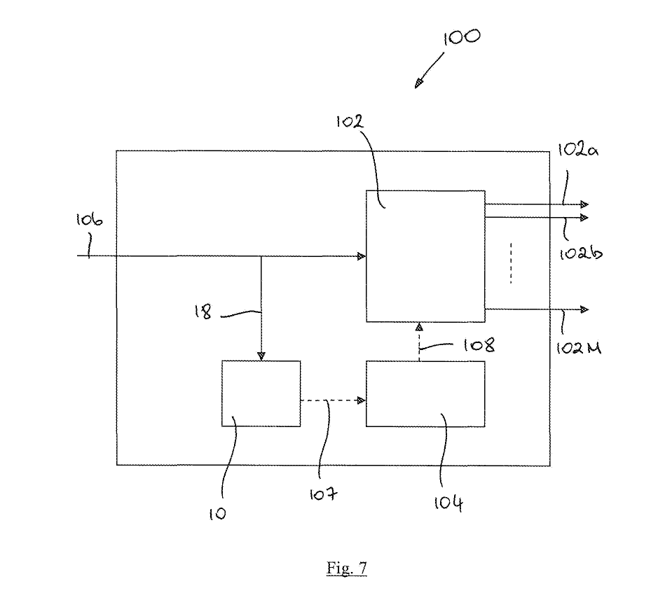

A sixth embodiment of the invention provides an optical network router 100, as shown in FIG. 7. The router 100 comprises an optical label extractor 10, as shown in FIG. 1, optical switch apparatus 102 and a controller 104.

The router 100 is arranged to receive input optical data packets 106, part of which is split and routed to the optical label extractor 10 to form input optical data packets 18. The remainder of the optical data packets 106 are routed to the optical switch apparatus 102 for routing to a selected output port 102a to 102M.

The controller 104 is arranged to receive a label signal 107, indicative of extracted optical labels 22, from the optical label extractor 10. The controller 104 is further arranged to generate a control signal 108 for controlling the optical switch apparatus 102. The control signal 108 is arranged to control the optical switch apparatus 102 in accordance with routing information provided within the extracted optical labels 22.

The optical switch apparatus 102 comprises a switching mechanism arranged to switch the input optical data packets 106 to respective ones of the outputs 102, in accordance with the routing information provided within the extracted optical labels 22 of the optical data packets 106. The construction and operation of optical switching apparatus 102 will be well known to the person skilled in the art and may comprise an optical-to-electrical-to-optical based optical switching apparatus in which the routing is carried out in the electrical domain, or may comprise an all-optical switching apparatus in which the routing is carried out in the optical domain.

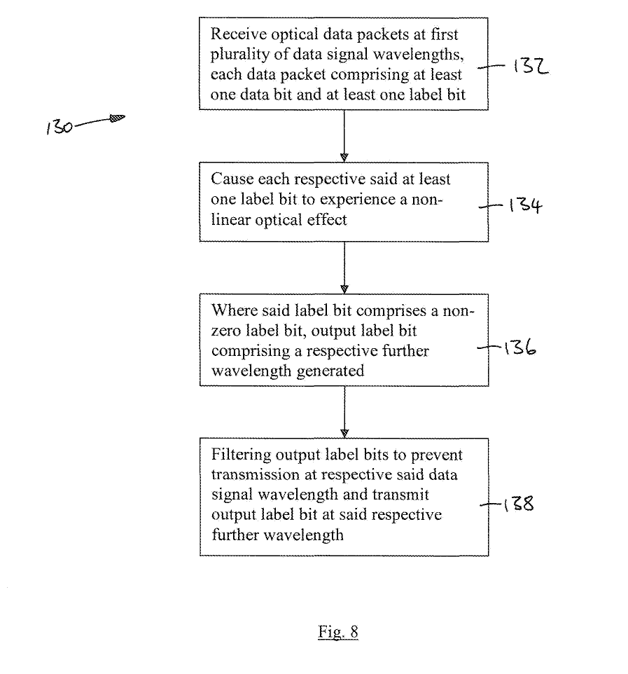

FIG. 8 shows the steps of a method 130 of extracting optical labels from optical data packets according to a seventh embodiment of the invention.

The method 130 comprises receiving optical data packets at a first plurality of data signal wavelengths 132. Each data packet comprises at least one data bit and at least one label bit. The method further comprises causing each respective said at least one label bit to experience a non-linear optical effect 134. Where a label bit comprises a non-zero label bit, as described above, an output label bit comprising a respective further wavelength is generated 136. The further wavelength is different for each data packet.

The method further comprises filtering any resulting output label bits to prevent transmission at the respective data signal wavelengths and transmitting a part of each output label bit at the respective further wavelength 138. The method 130 thus filters out the original label bits and the data bits at the data signal wavelengths and transmits only signals at the respective further wavelengths. The method 130 thereby extracts optical labels from optical data packets and generates extracted optical labels comprising the information of the label bits provided at the respective further wavelengths.

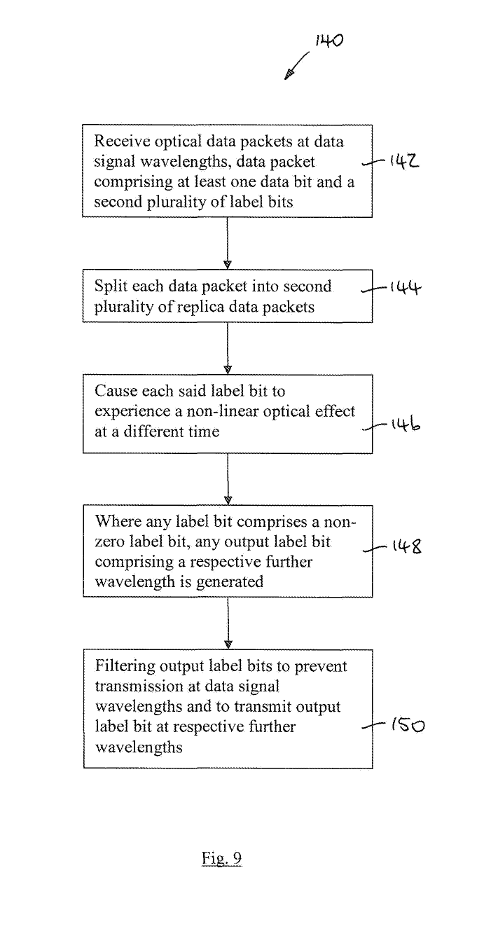

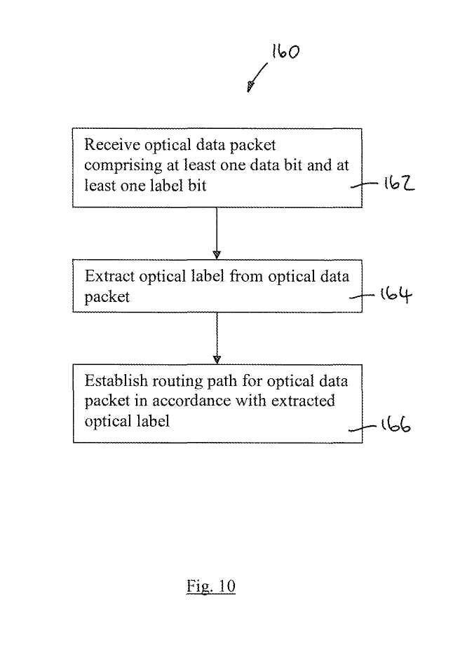

An eighth embodiment of the invention provides a method 140 of extracting optical labels from optical data packets, as shown in FIG. 9.

The method 140 comprises receiving optical data packets at a plurality of data signal wavelengths 142. Each data packet comprises at least one data bit and a second plurality of label bits. The method further comprises splitting each data packet into a said second plurality of replica data packets 144. The method 140 comprises causing each label bit to experience a non-linear optical effect at a different time 146. Each label bit is caused to experience a non-linear optical effect a different time 146. That is to say, the first label bit of each replica data packet experiences a non-linear optical effect at a first time, each second label bit experiences a non-linear optical effect at a second time, delayed from the first time, and so on. Where any label bit comprises a non-zero label bit, as described above, a respective output label bit comprising a respective further wavelength is generated 148.

The method further comprises filtering any output label bits that are generated to prevent transmission of any part of each output label bit at the respective data signal wavelength and to transmit a part of each output label bit at the respective further wavelength 150.

The method 140 thereby optically extracts labels from optical data packets and provides the labels in a temporally separate series. The method enables parallel label extraction from a plurality of optical data packets, the first label bit of each data packet being extracted at a first time, the second label bit of each data packet being extracted at a second, later time and so on.

Referring to FIG. 10, a ninth embodiment of the invention provides a method 160 of routing optical data packets. The method 160 comprises receiving optical data packets 162. Each data packet comprises at least one data bit and at least one label bit. The method further comprises extracting an optical label from each optical data packet 164. The optical labels may be extracted using the method steps of any of the above described methods 130, 140 of extracting optical labels from optical data packets.

The method 160 further comprises establishing a routing path for each said optical data packet in accordance with the respective extracted optical label 166.

1. An optical label extractor comprising:
a non-linear optical element arranged to receive optical data packets at a first plurality of data signal wavelengths, each said data packet comprising at least one data bit and at least one label bit;
a pump source arranged to pump said non-linear optical element such that any non-zero label bit at a respective data signal wavelength experiences a non-linear optical effect on propagation through said non-linear optical element and an output label bit comprising a respective further wavelength is thereby generated; and
optical filter apparatus arranged to receive any said output label bit from said non-linear optical element and being further arranged to prevent transmission of a part of said output label bit at said respective data signal wavelength and to transmit a part of said output label bit at said respective further wavelength.

2. An optical label extractor as claimed in claim 1, wherein said optical filter apparatus comprises a said first plurality of outputs and is arranged to transmit a part of each said output label bit at said respective further wavelength to a respective said output.

3. An optical label extractor as claimed in claim 1, wherein said pump source comprises an optical source arranged to generate a pump optical signal and to deliver said pump optical signal to said non-linear optical element and said non-linear optical effect comprises one of cross-phase modulation and four-wave-mixing.

4. An optical label extractor as claimed in claim 3, wherein each said optical data packet comprises a second plurality of label bits and said pump source further comprises a controller arranged to control said optical source to generate a pump optical signal comprising a said second plurality of pump pulses and to deliver said pump pulses to said non-linear optical element such that each said pump pulse at least partly temporally overlaps with a respective said label bit at the or each said data signal wavelength.

5. An optical label extractor as claimed in claim 3, wherein each said optical data packet comprises a third plurality of label bits and said optical source is arranged to generate a pump optical signal comprising a pump pulse and said optical label extractor further comprises:
first optical splitter apparatus arranged to split each said data packet into a said third plurality of replica data packets;
a said third plurality of said non-linear optical element, each of said non-linear optical elements being arranged to receive a respective one of said replica data packets;
a said third plurality of said optical filter apparatus;
second optical splitter apparatus arranged to split said pump pulse into a said third plurality of replica pump pulses and to deliver each said replica pump pulse to a respective said non-linear optical element; and
a said third plurality of time delay elements respectively provided between said second optical splitter apparatus and each said non-linear optical element, each said time delay element being arranged to apply a time delay of a different duration to a respective replica pump pulse,
such that each said replica pump pulse is delivered to said respective non-linear optical element at a different time and thus at least partly temporally overlaps with a different said label bit at the or each said data signal wavelength.

6. An optical label extractor as claimed in claim 1, wherein the or each said non-linear optical element comprises one of a semi-conductor optical amplifier and a non-linear optical waveguide.

7. An optical label extractor as claimed in claim 4, wherein each said data packet has a return-to-zero or non-return-to-zero data signal format and said pump optical signal is of a same said data signal format.

8. An optical label extractor as claimed in claim 1, wherein the or each said optical filter apparatus comprises an arrayed waveguide grating.

9. An optical label extractor as claimed in claim 1 wherein the or each said non-linear optical element is arranged to transmit each respective said data packet and the or each said optical filter apparatus is arranged to receive each respective said data packet and any respective said output label bit from said non-linear optical element and is further arranged to prevent transmission of each respective said data packet.

10. An optical network router comprising an optical label extractor according to claim 1, optical switch apparatus and a controller arranged to receive a label signal indicative of an extracted label from said label extractor and to generate a control signal for controlling said optical switch apparatus in accordance with said extracted label.

11. A method of extracting optical labels from optical data packets, the method comprising:
receiving optical data packets at a first plurality of data signal wavelengths, each said data packet comprising at least one data bit and at least one label bit;
causing each respective said at least one label bit to experience a non-linear optical effect such that where a respective said at least one label bit comprises a non-zero label bit a respective output label bit comprising a respective further wavelength is thereby generated; and
filtering any respective said output label bit to prevent transmission of a part of said output label at said respective data signal wavelength and to transmit a part of said output label bit at said respective further wavelength.

12. A method as claimed in claim 11, wherein each said optical data packet comprises a second plurality of label bits and said method comprises splitting each said optical data packet into a said second plurality of replica data packets, causing each of said second plurality of label bits of each said replica data packet to experience a non-linear optical effect at a respective different time and filtering each said output label bit to prevent transmission of a part of said output label at said respective data signal wavelength and to transmit a part of said output label bit at said respective further wavelength, such that spatially and temporally separated output label bits are transmitted.

13. A method as claimed in claim 11, wherein said non-linear optical effect comprises one of cross-phase modulation and four-wave-mixing.

14. A method as claimed in claim 11, wherein said method further comprises preventing transmission of each said data packet so that only said part of each said output label bit at said respective further wavelength is transmitted.

15. A method of routing optical data packets comprising:
receiving optical data packets to be routed, each said data packet comprising at least one data bit and at least one label bit;
extracting respective optical labels from said optical data packets according to the method of claim 11; and
establishing a routing path for each said optical data packet in accordance with said respective extracted optical label.
